(19) United States
(12) Patent Application Publication
(10) Pub. No.: US 2025/0150008 A1
(43) Pub. Date: May 8, 2025

(54) POWER TOOL AND CONTROL METHOD THEREFOR

(71) Applicant: Nanjing Chervon Industry Co., Ltd., Nanjing (CN)

(72) Inventor: Wenkang Tong, Nanjing (CN)

(21) Appl. No.: 18/814,780

(22) Filed: Aug. 26, 2024

(30) Foreign Application Priority Data
Nov. 7, 2023 (CN) 202311467289.3
Dec. 12, 2023 (CN) 202311706958.8

(51) Int. Cl. H02P 6/15; B23D 47/12; B25F 5/00

(52) U.S. Cl. CPC H02P 6/153; B23D 47/12; B25F 5/00

(57) ABSTRACT

A power tool includes a functional piece; an electric motor; a power supply device; a controller connected to the electric motor and used for controlling the operation of the electric motor; and a detection device connected to the electric motor and the controller and configured to detect the duration of each phase of the electric motor. The controller is configured to obtain the duration of a rising phase and the duration of a falling phase according to the duration of each phase of the electric motor and determine whether the electric motor has an uneven commutation phenomenon; and when the electric motor has the uneven commutation phenomenon, dynamically adjust a rising commutation point and/or a falling commutation point of the electric motor based.

### RELATED APPLICATION INFORMATION

This application claims the benefit under 35 U.S.C. § 119(a) of Chinese Patent Application No. 202311467289.3, filed on Nov. 7, 2023, and Chinese Patent Application No. 202311706958.8, filed on Dec. 12, 2023, which applications are incorporated herein by reference in their entireties.

### TECHNICAL FIELD

The present application relates to the technical field of power tools and, in particular, to a power tool and a control method therefor.

### BACKGROUND

The electric motor in a power tool is controlled by a controller to operate. The three-phase electric motor has six electrical angle sectors with equal electrical angles. The duration in which the rotor of the electric motor rotates in each electrical angle sector is the duration of each phase. However, when the power tool is under a heavy load, the durations of six phases corresponding to the preceding six electrical angle sectors may fluctuate due to the fluctuations in the characteristic parameters of components such as an inductor. The fluctuations in the duration of each phase of the electric motor may affect the determination of the locked rotor protection of the power tool, causing the power tool to enter the locked rotor protection in advance and negatively affecting the performance, efficiency, and user experience of the power tool and the electric motor.

This part provides background information related to the present application, and the background information is not necessarily the existing art.

### SUMMARY

A power tool includes a functional piece; an electric motor for driving the functional piece to operate; a power supply device for supplying power to at least the electric motor; and a controller connected to the electric motor and used for controlling the operation of the electric motor. The power tool further includes a detection device connected to the electric motor and the controller and configured to detect the duration of each phase of the electric motor, where the duration of each phase of the electric motor is the duration in which a rotor of the electric motor is located in each electrical angle sector. The controller is configured to obtain the duration of a rising phase and the duration of a falling phase of the electric motor according to the duration of each phase of the electric motor and determine whether the electric motor has an uneven commutation phenomenon based on the duration of the rising phase and the duration of the falling phase; and in the case where the electric motor has the uneven commutation phenomenon, dynamically adjust a rising commutation point and/or a falling commutation point of the electric motor based on the magnitude relationship between the duration of the rising phase and the duration of the falling phase; where the floating phase voltage increases from low to high within the duration of the rising phase, and the floating phase voltage decreases from high to low within the duration of the falling phase.

In some examples, the controller is configured to, in the case where the difference between the duration of the rising phase and the duration of the falling phase exceeds a preset difference threshold, determine that the electric motor has the uneven commutation phenomenon; or in the case where the ratio of the duration of the rising phase to the duration of the falling phase exceeds a preset ratio threshold, determine that the electric motor has the uneven commutation phenomenon.

In some examples, the electric motor is a three-phase electric motor, the electric motor has six electrical angle sectors and corresponding six-phase durations, and the six-phase durations are durations of rising phases and falling phases that alternate with the rising phases.

In some examples, the duration of the rising phase and the duration of the falling phase are durations of two adjacent phases; or the duration of the rising phase is the sum of durations of three rising phases generated by one rotation of the rotor of the electric motor, and the duration of the falling phase is the sum of durations of three falling phases generated by one rotation of the rotor of the electric motor.

In some examples, the controller is configured to adjust a first proportional point corresponding to the rising commutation point to change the trigger timing of the rising commutation point and, when the floating phase voltage of the electric motor rises from the lowest point to the first proportional point, control the electric motor to switch from a current rising phase to a next phase; and/or adjust a second proportional point corresponding to the falling commutation point to change the trigger timing of the falling commutation point and, when the floating phase voltage of the electric motor drops from the highest point to the second proportional point, control the electric motor to switch from a current falling phase to a next phase.

In some examples, the controller is configured to, in the case where the electric motor has the uneven commutation phenomenon, if the duration of the rising phase is greater than the duration of the falling phase, reduce the first proportional point and/or reduce the second proportional point.

In some examples, the controller is configured to, in the case where the electric motor has the uneven commutation phenomenon, if the duration of the rising phase is less than the duration of the falling phase, increase the first proportional point and/or increase the second proportional point.

In some examples, the controller is configured to adjust the first proportional point within a preset first proportional range and/or adjust the second proportional point within a preset second proportional range until the uneven commutation phenomenon of the electric motor is eliminated.

In some examples, the first proportional range is from 0.5 to 0.8, and the second proportional range is from 0.2 to 0.5.

In some examples, the controller is configured to adjust the first timer count corresponding to the rising commutation point to change the trigger timing of the rising commutation point and, when the timer increment reaches the first timer count after the electric motor enters the rising phase, control the electric motor to switch to a next phase; and/or adjust the second timer count corresponding to the falling commutation point to change the trigger timing of the falling commutation point and, when the timer increment reaches the second timer count after the electric motor enters the falling phase, control the electric motor to switch to a next phase.

A power tool includes a functional piece; an electric motor for driving the functional piece to operate; a power supply device for supplying power to at least the electric motor; and a controller connected to the electric motor and used for controlling the operation of the electric motor. The controller is configured to control the duration of each phase during the operation of the electric motor so that the duration of each phase of the electric motor remains basically the same, where the duration of each phase of the electric motor is the duration in which a rotor of the electric motor is located in each electrical angle sector.

A control method for a power tool includes detecting, by a detection device of the power tool, the duration of each phase of an electric motor of the power tool, where the duration of each phase of the electric motor is the duration in which a rotor of the electric motor is located in each electrical angle sector; obtaining, by a controller of the power tool, the duration of a rising phase and the duration of a falling phase of the electric motor according to the duration of each phase of the electric motor and determining whether the electric motor has an uneven commutation phenomenon based on the duration of the rising phase and the duration of the falling phase; and in the case where the electric motor has the uneven commutation phenomenon, dynamically adjusting, by the controller, a rising commutation point and/or a falling commutation point of the electric motor based on the magnitude relationship between the duration of the rising phase and the duration of the falling phase. The floating phase voltage increases from low to high within the duration of the rising phase, and the floating phase voltage decreases from high to low within the duration of the falling phase.

A power tool includes a functional piece; an electric motor for driving the functional piece to operate; a power supply device for supplying power to at least the electric motor; a driver circuit connected between the power supply device and the electric motor and used for transmitting the electrical energy provided by the power supply device from a direct current bus to the electric motor; and a controller for controlling the operation the electric motor. The power tool further includes a detection device connected to the electric motor and the controller and configured to detect a load parameter of the electric motor. The controller is configured to, in the case where the load parameter exceeds a corresponding threshold, determine a first voltage vector according to a first modulation index, overmodulate the first voltage vector to obtain a first modulated voltage vector, and output a first pulse-width modulation (PWM) signal corresponding to the first modulated voltage vector to the driver circuit, where the first modulation index is greater than or equal to 0.9069 and less than or equal to 1.

In some examples, the controller is configured to, in the case where the load parameter does not exceed the corresponding threshold, determine a second voltage vector according to a second modulation index and output a second PWM signal corresponding to the second voltage vector to the driver circuit, where the second modulation index is greater than or equal to 0 and less than 0.9069.

In some examples, the controller is configured to, in the case where the load parameter does not exceed the corresponding threshold, determine a second voltage vector according to a second modulation index, overmodulate the second voltage vector to obtain a second modulated voltage vector, and output a second PWM signal corresponding to the second modulated voltage vector to the driver circuit, where the second modulation index is greater than or equal to 0.9069 and less than the first modulation index.

In some examples, the controller is configured to, in the case where the load parameter changes from not exceeding the corresponding threshold to exceeding the corresponding threshold, control a modulation index for generating a PWM signal to smoothly transition from the second modulation index to the first modulation index; and/or in the case where the load parameter changes from exceeding the corresponding threshold to not exceeding the corresponding threshold, control the modulation index to smoothly transition from the first modulation index to the second modulation index.

In some examples, the controller is configured to, in the case where the load parameter changes from not exceeding the corresponding threshold to exceeding the corresponding threshold, control a modulation index to rise linearly from the second modulation index to the first modulation index within the first preset duration; and/or in the case where the load parameter changes from exceeding the corresponding threshold to not exceeding the corresponding threshold, control the modulation index to drop linearly from the first modulation index to the second modulation index within the second preset duration.

In some examples, the controller is configured to, in the case where the load parameter changes from not exceeding the corresponding threshold to exceeding the corresponding threshold, control a modulation index for generating a PWM signal to directly switch from the second modulation index to the first modulation index; and/or in the case where the load parameter changes from exceeding the corresponding threshold to not exceeding the corresponding threshold, control the modulation index to directly switch from the first modulation index to the second modulation index.

In some examples, the controller is configured to overmodulate a portion of the first voltage vector that exceeds a linear modulation region to obtain a first modulated voltage vector; and/or overmodulate a portion of the second voltage vector that exceeds the linear modulation region to obtain a second modulated voltage vector.

In some examples, the load parameter of the electric motor includes one or more of the current, voltage, rotational speed, torque, and freewheeling time of the electric motor.

In some examples, the phase current waveform of the electric motor is basically sinusoidal, and the phase voltages are basically 120° out of phase with each other.

A power tool includes a functional piece; an electric motor for driving the functional piece to operate; a power supply device for supplying power to at least the electric motor; a driver circuit connected between the power supply device and the electric motor and used for transmitting the electrical energy provided by the power supply device from a direct current bus to the electric motor; and a controller for controlling the operation of the electric motor. The controller is configured to adopt different modulation indices for different load parameters of the electric motor.

A control method for a power tool includes detecting, by a detection device of the power tool, a load parameter of an electric motor of the power tool; in the case where the load parameter exceeds a corresponding threshold, determining, by a controller of the power tool, a first voltage vector according to a first modulation index and overmodulating the first voltage vector to obtain a first modulated voltage vector; and outputting, by the controller, a first PWM signal corresponding to the first modulated voltage vector to a driver circuit of the power tool. The first modulation index is greater than or equal to 0.9069 and less than or equal to 1.

### BRIEF DESCRIPTION OF THE DRAWINGS

FIG. 1 is a perspective view of a power tool as an example of the present application.

FIG. 2 is a schematic diagram of electric control of the power tool shown in FIG. 1.

FIG. 3 is a schematic diagram of the phase voltages of an electric motor shown in FIG. 2.

FIG. 4A is a schematic diagram of the uneven commutation phenomenon in which the duration of a rising phase is greater than the duration of a falling phase in an electric motor shown in FIG. 2.

FIG. 4B is a schematic diagram of the uneven commutation phenomenon in which the duration of a rising phase is less than the duration of a falling phase in an electric motor shown in FIG. 2.

FIG. 5 is a flowchart of a control method for a power tool as an example of the present application.

FIG. 6A is a schematic diagram illustrating that a controller in the power tool shown in FIG. 2 determines voltage vectors.

FIG. 6B is a schematic diagram illustrating that a controller in the power tool shown in FIG. 2 determines modulated voltage vectors.

FIG. 7A is a schematic diagram of the phase voltage of an electric motor with a low modulation index in the power tool shown in FIG. 2.

FIG. 7B is a schematic diagram of the phase voltage of an electric motor with a high modulation index in the power tool shown in FIG. 2.

FIG. 8A is a schematic diagram of the phase current of an electric motor with a low modulation index in the power tool shown in FIG. 2.

FIG. 8B is a schematic diagram of the phase current of an electric motor with a high modulation index in the power tool shown in FIG. 2.

FIG. 9 is a schematic diagram of electric control of a controller in the power tool shown in FIG. 2 controlling an electric motor to operate.

FIG. 10 is a control flowchart of a power tool according to an example of the present application.

### DETAILED DESCRIPTION

Before any example of the present application is explained in detail, it is to be understood that the present application is not limited to its application to the structural details and the arrangement of components set forth in the following description or illustrated in the preceding drawings.

In the present application, the terms “comprising”, “including”, “having”, or any other variation thereof are intended to cover an inclusive inclusion such that a process, method, article, or device including a series of elements includes not only those series of elements, but also other elements not expressly listed, or elements inherent in the process, method, article, or device. Without further limitations, an element defined by the phrase “comprising a . . . ” does not exclude the presence of additional identical elements in the process, method, article, or device including this element.

In the present application, the term “and/or” is used for describing the association relationship between associated objects, which means that three types of relationships may exist. For example, A and/or B may indicate that A exists alone, A and B exist simultaneously, and B exists alone. In addition, the character “/” in the present application generally indicates the “and/or” relationship between the associated objects before and after the character “/”.

In the present application, the terms “connection”, “combination”, “coupling”, and “mounting” may be the direct connection, combination, coupling, or mounting and may also be the indirect connection, combination, coupling, or mounting. Among them, for example, direct connection means that two parts or assemblies are connected together without intermediate pieces, and indirect connection means that two parts or assemblies are separately connected to at least one intermediate piece and the two parts or assemblies are connected to each other by the at least one intermediate piece. In addition, “connection” and “coupling” are not limited to physical or mechanical connections or couplings and may include electrical connections or couplings.

In the present application, it is to be understood by those of ordinary skill in the art that a relative term (such as “about”, “approximately”, or “basically”) used in conjunction with a quantity or a condition includes a stated value and has a meaning dictated by the context. For example, the relative term includes at least a degree of error associated with the measurement of a particular value, a tolerance caused by manufacturing, assembly, and use associated with the particular value, and the like. Such a relative term should also be considered as disclosing the range defined by the absolute values of the two endpoints. The relative term may refer to that an indicated value is added or reduced by a certain percentage (such as 1%, 5%, 10%, or more). A value not modified by the relative term should also be disclosed as a particular value with a tolerance. In addition, when expressing a relative angular position relationship (for example, basically parallel or basically perpendicular), “basically” may refer to that a certain degree (such as 1 degree, 5 degrees, 10 degrees, or more) is added to or subtracted from the indicated angle.

In the present application, those of ordinary skill in the art will understand that a function implemented by an assembly may be implemented by one assembly, multiple assemblies, one part, or multiple parts. Similarly, a function implemented by a part may be implemented by one part, one assembly, or a combination of parts.

In the present application, the terms “up”, “down”, “left”, “right”, “front”, “rear”, and other orientation words are described based on the orientation or positional relationship shown in the drawings and should not be understood as limitations to the examples of the present application. In addition, in this context, it also needs to be understood that when it is mentioned that an element is connected “above” or “below” another element, the element not only can be directly connected “above” or “below” the other element but also can be indirectly connected “above” or “below” the other element through an intermediate element. Further, it should be understood that orientation words such as the upper side, lower side, left side, right side, front side, and rear side not only represent perfect orientations but also may be understood as lateral orientations. For example, the lower part may include directly below, lower left, lower right, lower front, and lower back.

In the present application, the terms “controller”, “processor”, “central processing unit”, “CPU”, and “MCU” are interchangeable. When a unit such as the “controller”, the “processor”, the “central processing unit”, the “CPU”, or the “MCU” is configured to implement specific functions, these functions may be implemented by a single preceding unit or multiple preceding units unless otherwise indicated.

In the present application, the term “device”, “module”, or “unit” is configured to implement a specific function in the form of hardware or software.

In the present application, the terms “computing”, “judging”, “controlling”, “determining”, “identifying”, and the like refer to the operations and processes of a computer system or similar electronic computing device (for example, the controller or the processor).

Technical solutions of the present application are described below in detail in conjunction with drawings and examples.

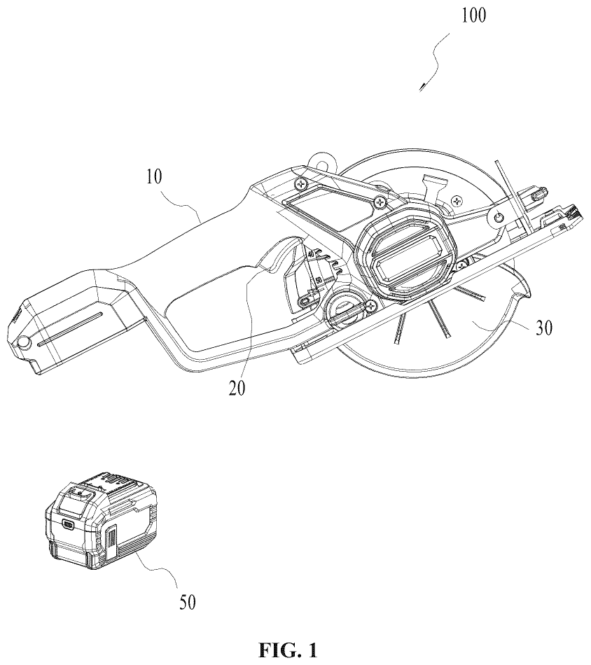

FIG. 1 shows a power tool 100 as an example of the present application. The power tool 100 shown in FIG. 1 is an electric circular saw 100a. In other examples, the power tool 100 may be other types of handheld power tools such as a jigsaw, a reciprocating saw, an electric drill, and an impact wrench, table tools such as a miter saw and a table saw, or outdoor power devices such as a mower and a snow thrower. It is to be understood that the power tool 100 using the technical solutions of the present application is not limited to the electric circular saw, nor is it limited to the types of tools described above.

Referring to FIG. 1, the power tool 100 includes a housing 10, an operating member 20, and a functional piece 30. The housing 10 constitutes a body of the power tool 100, connects or supports the preceding components, and forms an accommodation space capable of accommodating or partially accommodating the preceding components. The operating member 20 is operated by a user to start or stop an electric motor 40 to be described below, or the operating member 20 is operated by the user to adjust the rotational speed of the electric motor 40 or implement other multiple functions. The functional piece 30 is a component in the power tool 100 that actually performs operations such as cutting, tightening, grinding, and impacting. The electric circular saw is used as an example, and the functional piece 30 is a circular saw blade. The functional piece 30 of another power tool 100 may be a chain, a drill bit, or the like.

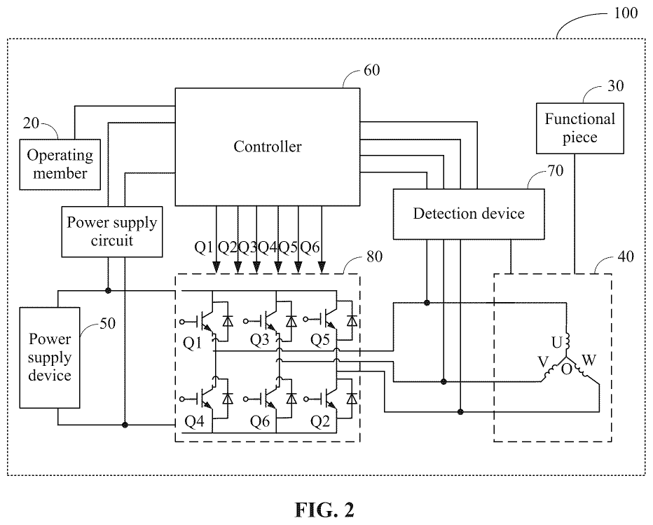

Referring to FIG. 2, in addition to the housing 10, the operating member 20, and the functional piece 30, the power tool 100 further includes the electric motor 40, a power supply device 50, a controller 60, and a detection device 70. The electric motor 40 is a prime mover of the power tool 100. When a motor shaft of the electric motor 40 rotates, the functional piece 30 may be driven directly to operate or may be driven indirectly through a transmission assembly to operate. The power supply device 50 can supply electrical energy to at least the electric motor 40 and can also supply power to the controller 60, the detection device 70, or other related circuits. In some examples, the power supply device 50 is a battery pack detachably connected to the power tool 100. In other examples, the power tool 100 may be powered using mains power and the alternating current power supply in conjunction with the power adapter or related circuits such as the transformer circuit, the rectifier circuit, and the voltage regulator circuit.

The controller 60 may be an MCU, an advanced reduced instruction set computing machine (ARM), a digital signal processor (DSP), or the like. The controller 60 is electrically connected to the electric motor 40 and can run relevant control programs and output a control signal to the electric motor 40 so that the electric motor 40 operates in the intended correct manner. Usually, a driving device such as a three-phase bridge inverter or an integrated driver chip should be connected between the controller 60 and the electric motor 40. The control signal outputted by the controller 60 is converted by the driving device into a drive signal that actually drives the electric motor 40 to rotate.

The electric motor 40 may be a three-phase electric motor 40, and the three phases of the three-phase electric motor 40 may be recorded as the A phase, the B phase, and the C phase, respectively. Although the numbers of windings, the connection methods, and the numbers of magnetic poles may be different, the three-phase electric motor 40 should have six electrical angle sectors. The six electrical angle sectors have a rotation sequence and add up to 360°. The six consecutive electrical angle sectors may correspond to six stages in which the AB phase, AC phase, BC phase, BA phase, CA phase, and CB phase of the three-phase electric motor 40 are turned on in sequence, respectively. The correspondence between the two represents that in a stage in which two phases of the three-phase electric motor are turned on, the rotor of the electric motor is affected by the corresponding stator magnetic field and rotates in the corresponding electrical angle sector. In other words, the rotor of the electric motor passes through the preceding six electrical angle sectors in the preceding six two-phase conduction cases to complete one rotation. As shown in FIG. 2, six switching transistors in the driving device may be recorded as Q1, Q2, Q3, Q4, Q5, and Q6, respectively. When driving the electric motor 40 to rotate, the controller 60 outputs the control signal that can turn on two switching transistors in the driving device to achieve the conduction of the corresponding two phases in the three-phase electric motor 40. Specifically, the controller 60 may output control signals to turn on the switching transistors Q1Q4, Q1Q2, Q3Q2, Q3Q6, Q5Q6, and Q5Q4 in the driving device in sequence. Correspondingly, the AB phase, AC phase, BC phase, BA phase, CA phase, and CB phase of the three-phase electric motor 40 can be turned on in sequence, thereby achieving the drive and control of the rotation of the electric motor 40. It is to be understood that the reverse rotation process of the electric motor 40 may be deduced based on the above, and the details are not repeated. In some examples, the controller 60 controls the operation of the electric motor 40 in a six-step commutation method.

The detection device 70 is electrically connected to the electric motor 40 and the controller 60, detects the duration of each phase of the electric motor 40, and transmits the measured duration of each phase to the controller 60. Specifically, the detection device 70 detects the durations of six phases of the three-phase electric motor 40. It is to be noted that the “phase” in “the duration of each phase” described here is different from the “phase” in “the three-phase electric motor”. The duration of one of the six phases is the duration of one of the six stages in which the AB phase, AC phase, BC phase, BA phase, CA phase, and CB phase of the three-phase electric motor 40 are turned on in sequence, that is, the duration in which the rotor of the electric motor is located in one of the six electrical angle sectors.

The detection device 70 detects the duration of each phase of the electric motor 40 in multiple optional methods. Specifically, the detection device 70 may directly obtain or indirectly calculate the duration of each phase of the electric motor 40 based on various parameters of the electric motor 40 such as the phase voltage and phase current of the electric motor 40. The specific process of calculating the duration of each phase may be adaptively designed depending on whether the electric motor 40 is equipped with a position sensor such as a Hall sensor and what control algorithm the controller 60 specifically adopts. In an example, the detection device 70 may use a timer to count the duration of each phase, and the magnitude of the timer count value in each phase represents the duration of each phase.

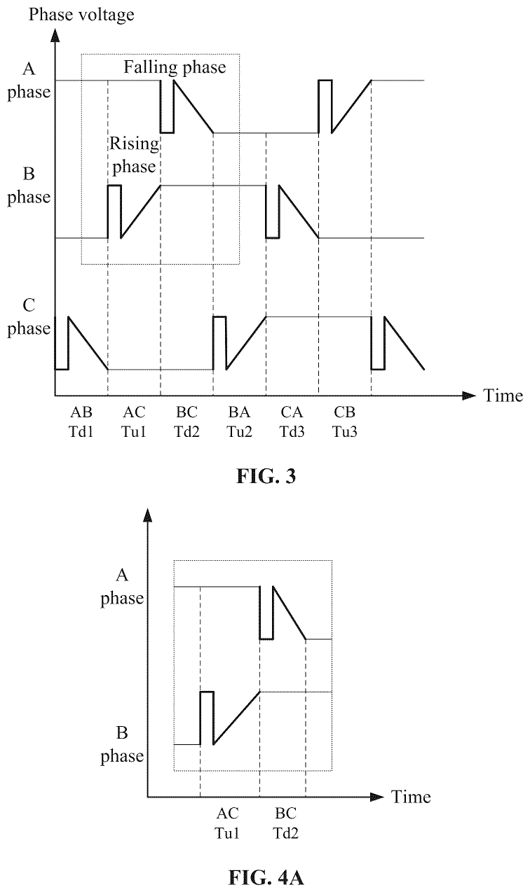

To clarify the following solutions, the durations of six phases of the three-phase electric motor 40 are further described in detail here. Referring to FIG. 3, FIG. 3 shows the changing waveforms of the A-phase voltage, the B-phase voltage, and the C-phase voltage of the three-phase electric motor 40 in ideal conditions during one rotation of the rotor of the electric motor. The six phases of the three-phase electric motor may be divided and defined as rising phases and falling phases, where the rising phase is a phase in which the floating phase voltage increases from low to high. For example, the AB phase is turned on in the previous phase of the stage in which the AC phase of the three-phase electric motor 40 is turned on, the BC phase is turned on in the next phase of the stage in which the AC phase of the three-phase electric motor 40 is turned on, and the current floating phase voltage, that is, the B phase voltage increases from low to high in the current stage; therefore, the stage in which the AC phase is turned on is the rising phase. The falling phase is a phase in which the floating phase voltage decreases from high to low. For example, the AC phase is turned on in the previous phase of the stage in which the BC phase of the three-phase electric motor 40 is turned on, the BA phase is turned on in the next phase of the stage in which the BC phase of the three-phase electric motor 40 is turned on, and the current floating phase voltage, that is, the A phase voltage decreases from high to low in the current stage; therefore, the stage in which the BC phase is turned on is the falling phase. In addition, it is not difficult to find that according to the conduction sequence described above, during one rotation of the rotor of the electric motor, the rising phases alternate with the falling phases. The preceding durations of the six phases include the durations of three rising phases and the durations of three falling phases. In ideal conditions, the duration of each phase should be the same.

If a static solution that does not take into account changes in the working conditions of the power tool 100 is always used to control the operation of the electric motor 40, the durations of six phases of the three-phase electric motor 40 are generally unequal. This phenomenon may be referred to as an uneven commutation phenomenon in the electric motor control. Of course, in addition to the unequal durations of the phases, the uneven commutation phenomenon may have other external manifestations. In some examples, the detection of other parameters is introduced into the solution to determine whether the electric motor has the uneven commutation phenomenon. In scenarios where the temperature rises, for example, in a scenario where the power tool 100 is under a heavy load, the characteristic parameters of components such as an inductor may fluctuate more significantly, the duration of each phase of the electric motor 40 fluctuates more significantly, the operation of the electric motor 40 becomes unsmooth, and the determination of the controller 60 in the power tool 100 on the locked rotor protection is affected. For example, it is assumed that the duration of each phase of the electric motor 40 is theoretically 900 μs, and the reference duration in which the controller 60 determines whether the electric motor 40 needs to enter the locked rotor protection is 1000 μs. If the duration of a certain phase of the electric motor 40 exceeds 1000 μs due to the preceding problem, the controller 60 makes a misjudgment and causes the power tool 100 to enter the locked rotor protection in advance. This misjudgment cannot be solved by simply increasing the reference duration of the locked rotor protection. Simply increasing the reference duration increases the current of the relevant circuit when the power tool is under a heavy load and increases the probability of metal-oxide-semiconductor (MOS) damage. Therefore, the preceding uneven commutation phenomenon of the electric motor may have adverse effects on the efficiency, performance, user experience, and other aspects of the power tool 100. In the present application, through the detection device 70 described above and the design of the configuration of the controller 60 to be described below, the uneven commutation phenomenon is eliminated, thereby ensuring that the power tool 100 performs various operations efficiently and accurately.

After obtaining the duration of each phase of the electric motor 40 detected by the detection device, the controller 60 can determine the duration of the rising phase and the duration of the falling phase. The duration of the rising phase includes the duration of one or more rising phases, and the duration of the falling phase includes the duration of one or more falling phases. In addition, usually, the number of rising phases included in the duration of the rising phase is equal to the number of falling phases included in the duration of the falling phase, thereby facilitating subsequent comparison and determination. In some examples, after the controller 60 obtains the duration of each phase of the electric motor 40, since the durations of the six phases in one cycle are the durations of the rising phases and the falling phases that alternate with the rising phases, the duration of the rising phase and the duration of the falling phase may be determined according to the durations of any two adjacent phases. In this example, each of the duration of the rising phase and the duration of the falling phase is the duration of one phase. As shown in FIG. 3, the duration of the rising phase may be the duration Tᵤ₁ of the AC phase conduction stage, and the duration of the falling phase may be the duration T_{d1} of the AB phase conduction stage; or the duration of the rising phase is the duration Tᵤ₂ of the BA phase conduction stage, and the duration of the falling phase is the duration T_{d2} of the BC phase conduction stage; or the duration of the rising phase is the duration Tᵤ₃ of the CB phase conduction stage, and the duration of the falling phase is the duration T_{d3} of the CA phase conduction stage. In other examples, after obtaining the duration of each phase of the electric motor 40, the controller 60 may determine the sum of the durations of the three rising phases in one cycle as the duration of the rising phase and determine the sum of the durations of the three falling phases in the same cycle, that is, the sum of the durations of the other three phases in the same cycle as the duration of the falling phase. In this example, each of the duration of the rising phase and the duration of the falling phase is the duration of three phases. As shown in FIG. 3, the duration of the rising phase is Tᵤ₁+Tᵤ₂+Tᵤ₃, and the duration of the falling phase is T_{d1}+T_{d2}+T_{d3}.

Then, based on the determined duration of the rising phase and the determined duration of the falling phase, the controller 60 may determine whether the electric motor 40 of the power tool 100 currently has the uneven commutation phenomenon. In some examples, the controller 60 may obtain a difference between the duration of the rising phase and the duration of the falling phase and determine whether the difference between the duration of the rising phase and the duration of the falling phase exceeds a preset difference threshold. If so, the controller 60 determines that the electric motor 40 has the uneven commutation phenomenon. In other examples, the controller 60 may obtain the ratio of the duration of the rising phase to the duration of the falling phase and determine whether the ratio of the duration of the rising phase to the duration of the falling phase exceeds a preset ratio threshold. If so, the controller 60 determines that the electric motor 40 has the uneven commutation phenomenon.

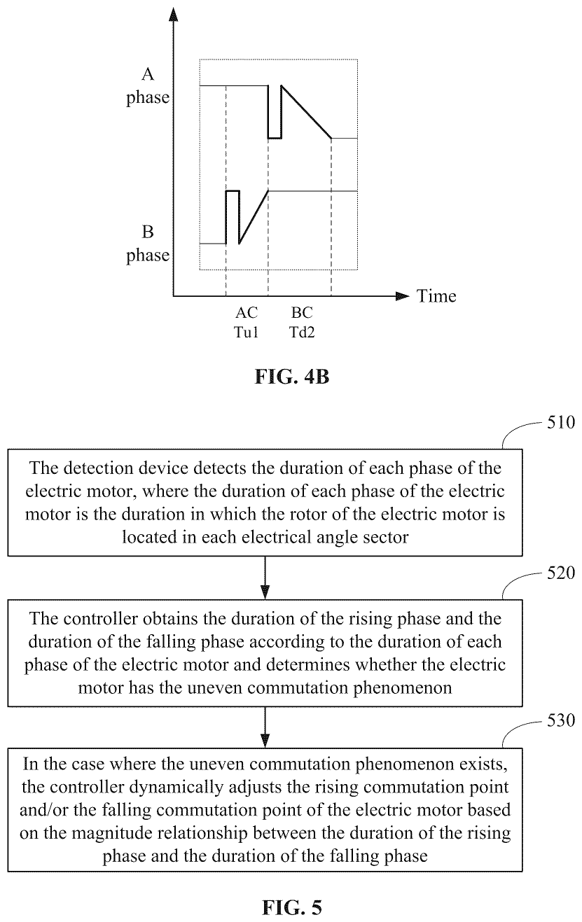

Referring to FIGS. 4A and 4B, the case where each of the duration of the rising phase and the duration of the falling phase is the duration of one phase and the rising phase and the falling phase are adjacent is used as an example, the duration of the rising phase is the duration Tᵤ₁ of the AC phase conduction stage in FIG. 3, and the duration of the falling phase is the duration T_{d2} of the BC phase conduction stage in FIG. 3. The uneven commutation phenomenon in the electric motor 40 may be divided into two categories. In the case where the difference between the duration of the rising phase and the duration of the falling phase or the ratio of the duration of the rising phase to the duration of the falling phase exceeds a corresponding threshold, first, as shown in FIG. 4A, the duration of the rising phase is greater than the duration of the falling phase, and the duration Tᵤ₁ of the AC phase conduction stage is greater than the duration T_{d2} of the BC phase conduction stage; second, as shown in FIG. 4B, the duration of the rising phase is less than the duration of the falling phase, and the duration Tᵤ₁ of the AC phase conduction stage is less than the duration T_{d2} of the BC phase conduction stage.

Then, after determining that the electric motor 40 of the power tool 100 currently has the uneven commutation phenomenon, the controller 60 can dynamically adjust a rising commutation point and/or a falling commutation point of the electric motor 40 based on the magnitude relationship between the duration of the rising phase and the duration of the falling phase, thereby eliminating the uneven commutation phenomenon of the electric motor 40. Based on the above, the controller 60 outputs the control signal to turn on the switching transistors in the driving device to turn on two different phases of the three phases. In the preceding control action, the controller 60 is triggered to switch the control signal outputted by the controller 60 so that the turned-on switching transistors or the turned-on two phases of the three-phase electric motor 40 are switched after a certain delay at a trigger point which is referred to as the commutation point. The commutation point is the trigger timing for the controller 60 to control the electric motor 40 to switch from the current phase to the next phase. The rising commutation point is defined as the trigger point for switching from the rising phase to the next phase, and the falling commutation point is defined as the trigger point for switching from the falling phase to the next phase.

The controller 60 dynamically adjusts the rising commutation point and/or the falling commutation point in multiple optional methods. In a method, the controller 60 may control the electric motor 40 to switch between six phases based on the proportional point. When the uneven commutation phenomenon exists, the controller 60 dynamically adjusts the preceding proportional point to eliminate the uneven commutation phenomenon.

The proportional point is the ratio of the floating phase voltage to the upper bridge turn-on phase voltage. When the floating phase voltage increases or decreases to the corresponding proportional point after the freewheeling ends, the controller 60 controls the electric motor 40 to switch from the current phase to the next phase. The first proportional point corresponds to the rising commutation point. The AC phase conduction stage is used as an example. The floating phase voltage is the B phase voltage, the upper bridge turn-on phase voltage is the A phase voltage, and the amplitude of the upper bridge turn-on phase voltage is regarded as 1 unit. Assuming that the original first proportional point is 0.6, when the amplitude of the floating phase voltage, that is, the B phase voltage, increases from the lowest point 0 to the first proportional point 0.6 after the freewheeling ends, the controller 60 controls the electric motor 40 to switch from the AC phase conduction stage to the BC phase conduction stage. The second proportional point corresponds to the falling commutation point. The BC phase conduction stage is used as an example. The floating phase voltage is the A phase voltage, and the upper bridge turn-on phase voltage is the C phase voltage. Assuming that the original second proportional point is 0.4, when the amplitude of the floating phase voltage, that is, the A phase voltage, decreases from the highest point 1 to the second proportional point 0.4 after the freewheeling ends, the controller 60 controls the electric motor 40 to switch from the BC phase conduction stage to the BA phase conduction stage.

In some examples, after the controller 60 determines that the electric motor 40 has the uneven commutation phenomenon, in the case where the duration of the rising phase is greater than the duration of the falling phase as shown in FIG. 4A, the first proportional point corresponding to the rising commutation point may be reduced, and/or the second proportional point corresponding to the falling commutation point may be reduced. Specifically, in conjunction with FIG. 4A, when the duration Tᵤ₁ of the AC phase conduction stage is greater than the duration T_{d2} of the BC phase conduction stage, the controller 60 may reduce the first proportional point and/or the second proportional point. Assuming that the original first proportional point is 0.6, the second proportional point is 0.4, and the amplitude of the upper bridge turn-on phase voltage is 1 unit, if the first proportional point is reduced to 0.59, the commutation point of the AC phase conduction stage changes from the original B phase voltage amplitude increasing to 0.6 to trigger commutation to increasing to 0.59 to trigger commutation, and the duration Tᵤ₁ of the AC phase conduction stage is relatively reduced to be gradually balanced with the duration T_{d2} of the BC phase conduction stage; if the second commutation point is reduced to 0.39, the commutation point of the BC phase conduction stage changes from the original A phase voltage amplitude decreasing to 0.4 to trigger commutation to decreasing to 0.39 to trigger commutation, and the duration T_{d2} of the BC phase conduction stage is relatively increased to be gradually balanced with the duration Tᵤ₁ of the AC phase conduction stage, thereby eliminating the uneven commutation phenomenon.

In other examples, after the controller 60 determines that the electric motor 40 has the uneven commutation phenomenon, in the case where the duration of the rising phase is less than the duration of the falling phase as shown in FIG. 4B, the first proportional point corresponding to the rising commutation point may be increased, and/or the second proportional point corresponding to the falling commutation point may be increased. Specifically, in conjunction with FIG. 4B, when the duration Tᵤ₁ of the AC phase conduction stage is less than the duration T_{d2} of the BC phase conduction stage, the controller 60 may increase the first proportional point and/or the second proportional point. If the first proportional point is increased to 0.61, the commutation point of the AC phase conduction stage changes from the original B phase voltage amplitude increasing to 0.6 to trigger commutation to increasing to 0.61 to trigger commutation, and the duration Tᵤ₁ of the AC phase conduction stage is relatively increased to be gradually balanced with the duration T_{d2} of the BC phase conduction stage; if the second commutation point is increased to 0.41, the commutation point of the BC phase conduction stage changes from the original A phase voltage amplitude decreasing to 0.4 to trigger commutation to decreasing to 0.41 to trigger commutation, and the duration T_{d2} of the BC phase conduction stage is relatively reduced to be gradually balanced with the duration Tᵤ₁ of the AC phase conduction stage, thereby eliminating the uneven commutation phenomenon.

In some examples, the controller 60 adjusts the first proportional point and/or the second proportional point in a stepping method, and the step amount of a single adjustment of the first proportional point and/or the second proportional point ranges from 0.002 to 0.01.

In some examples, the controller 60 adjusts the preceding proportional points within corresponding preset proportional ranges. Specifically, the controller 60 may dynamically adjust the first proportional point within a first proportional range, and the value of the first proportional point does not exceed the upper and lower limits of the first proportional range; and/or the controller 60 may dynamically adjust the second proportional point within a second proportional range, and the value of the second proportional point does not exceed the upper and lower limits of the second proportional range until the uneven commutation phenomenon of the electric motor 40 is eliminated. In some examples, the first proportional range corresponding to the rising commutation point or the first proportional point is from 0.5 to 0.8, and the second proportional range corresponding to the falling commutation point or the second proportional point is from 0.2 to 0.5. In other examples, the first proportional range is from 0.55 to 0.65, and the second proportional range is from 0.35 to 0.45.

In another example, the controller 60 uses the timer to control the electric motor 40 to switch among the six phases. When the uneven commutation phenomenon exists, the controller 60 eliminates the uneven commutation phenomenon by dynamically adjusting the timer count referenced during commutation. Specifically, the controller 60 may control the timer to start counting after the electric motor 40 enters each phase. When the timer increment reaches the corresponding timer count, the electric motor 40 is controlled to switch from the current phase to the next phase.

The first timer count corresponds to the rising commutation point. The AC phase conduction stage is used as an example. After the electric motor 40 enters this stage, the timer increment increases from 0. When the timer increment reaches the first timer count, the controller 60 controls the electric motor 40 to switch from AC phase conduction to BC phase conduction. The second timer count corresponds to the falling commutation point. The BC phase conduction stage is used as an example. After the electric motor 40 enters this stage, the timer increment increases from 0. When the timer increment reaches the second timer count, the controller 60 controls the electric motor 40 to switch from BC phase conduction to BA phase conduction. In some examples, after the controller 60 determines that the electric motor 40 has the uneven commutation phenomenon, in the case where the duration of the rising phase is greater than the duration of the falling phase as shown in FIG. 4A, the first timer count may be reduced, and/or the second timer count may be increased. In other examples, after the controller 60 determines that the electric motor 40 has the uneven commutation phenomenon, in the case where the duration of the rising phase is less than the duration of the falling phase as shown in FIG. 4B, the first timer count may be increased, and/or the second timer count may be reduced so that the duration Tᵤ₁ of the AC phase conduction stage is gradually balanced with the duration T_{d2} of the BC phase conduction stage, thereby eliminating the uneven commutation phenomenon.

It is to be understood that dynamically adjusting, by the controller 60, the rising commutation point and/or the falling commutation point is only one of the methods for the controller 60 to control the electric motor 40 to eliminate uneven commutation. In some examples, the controller 60 may eliminate the uneven commutation phenomenon of the electric motor 40 without controlling the commutation points. Specifically, which method to be used for the controller 60 to control the electric motor 40 to eliminate uneven commutation may be affected by the structure of the electric motor 40, the algorithm used by the controller 60 to control the electric motor 40, and the like. To sum up, the controller 60 may be configured to control the duration of each phase during the operation of the electric motor 40 and keep the duration of each phase basically the same, that is, the difference or ratio between the durations of phases of the electric motor 40 is within the allowable deviation range.

The benefit of the present application lies in the following: the duration of each phase of the electric motor is detected, and whether the electric motor currently has the uneven commutation phenomenon is determined according to the duration of each phase of the electric motor; and in the case where the phenomenon exists, the uneven commutation phenomenon is eliminated by dynamically adjusting the rising commutation point and/or the falling commutation point, thereby avoiding problems such as misjudgment of locked rotor protection caused by fluctuations in the duration of each phase when the power tool is under a heavy load, and ensuring that the electric motor in the power tool can always operate normally and smoothly, which is conducive to improving the tool efficiency and performance and optimizing the user experience.

After experimental verification, for the same power tool, in the case where the reference duration of locked rotor protection remains unchanged, before the preceding technical solution is adopted, the load upper limit is 7 kg; after the solution in the present application is adopted, the load upper limit is more than 8.5 kg so that the performance of every aspect of the power tool and its electric motor can be significantly improved.

Correspondingly, referring to FIG. 5, the present application further provides a control method for the power tool 100, which is applied to various types of power tools 100 and may include the steps below.

In 510, the detection device of the power tool 100 detects the duration of each phase of the electric motor 40 of the power tool 100, where the duration of each phase of the electric motor 40 is the duration in which the rotor of the electric motor is located in each electrical angle sector.

In 520, the controller 60 of the power tool 100 obtains the duration of the rising phase and the duration of the falling phase of the electric motor 40 according to the duration of each phase of the electric motor 40 and determines whether the electric motor 40 has the uneven commutation phenomenon based on the duration of the rising phase and the duration of the falling phase.

In 530, in the case where the electric motor 40 has the uneven commutation phenomenon, the controller 60 dynamically adjusts the rising commutation point and/or the falling commutation point of the electric motor 40 based on the magnitude relationship between the duration of the rising phase and the duration of the falling phase.

The floating phase voltage increases from low to high within the duration of the rising phase, and the floating phase voltage decreases from high to low within the duration of the falling phase.

The present application further provides another solution for improving the output performance of the power tool. As shown in FIG. 2, the power tool 100 may include the housing 10, the operating member 20, and the functional piece 30 and may further include the electric motor 40, the power supply device 50, the controller 60, the detection device 70, and a driver circuit 80. In some examples, the electric motor 40 is a brushless motor. In other examples, the electric motor 40 is a sensorless brushless motor.

The controller 60 can run relevant control programs and output control signals such as PWM signals to the driver circuit 80 so that the driver circuit 80 drives the electric motor 40 to operate in the intended manner. The driver circuit 80 is located between the power supply device 50 and the electric motor 40 and connects the power supply device 50 to the electric motor 40. The driver circuit 80 is also connected to the controller 60 and receives the control signals such as the PWM signals from the controller 60. The driver circuit 80 can convert the preceding control signals into drive signals that ultimately drive the electric motor 40 to operate and transmit the electrical energy provided by the power supply device 50 to the electric motor through a direct current bus. In some examples, the driver circuit 80 may include a three-phase bridge circuit that may be formed by three switching transistors as the upper half bridge and three switching transistors as the lower half bridge. The three switching transistors Q1, Q3, and Q5 as the upper half bridge are connected between a power supply terminal of the power supply device 50 and the phase coils of the electric motor 40, and the three switching transistors Q2, Q4, and Q6 as the lower half bridge are connected between the phase coils of the electric motor 40 and the ground wire. The preceding switching transistors may be field-effect transistors or insulated-gate bipolar transistors. In other examples, the driver circuit 80 may also be an integrated driver chip.

The detection device 70 is connected to the electric motor 40 and the controller 60 and can detect the current load of the electric motor 40 and transmit it to the controller 60. Specifically, the detection device 70 can detect at least one load parameter related to the load of the electric motor 40 and transmit it to the controller 60. In some examples, the load parameters of the electric motor 40 detected by the detection device 70 include, but are not limited to, the current, voltage, rotational speed, torque, freewheeling time, and temperature of the electric motor 40, where the current of the electric motor 40 may include the phase current, the bus current, or the like, the voltage of the electric motor 40 may include the phase voltage, the bus voltage, or the like, and the temperature of the electric motor 40 may include the MOS temperature, the ambient temperature, or the like.

After receiving the load parameter transmitted by the detection device 70, the controller 60 may determine whether the load parameter exceeds the corresponding threshold, thereby determining whether the electric motor 40 is currently in a no load/light load working condition or a heavy load working condition. Specifically, the controller 60 may compare the load parameter or the calculation value of the load parameter with the corresponding threshold, determine that the electric motor 40 is currently in the heavy load working condition in the case where the threshold is exceeded, and determine that the electric motor 40 is in the no load/light load working condition in the case where the threshold is not exceeded. In some examples, the controller 60 may determine that the power tool 100 is under a heavy load when the current rotational speed of the electric motor 40 is less than a preset rotational speed threshold, or the current current of the electric motor 40 exceeds a preset current threshold, or the current voltage of the electric motor 40 exceeds a preset voltage threshold. In other examples, the controller 60 may determine that the power tool 100 is under a heavy load when the current rotational speed of the electric motor 40 is less than a rotational speed threshold corresponding to the current temperature of the electric motor 40. In other examples, the controller 60 may determine that the power tool 100 is under a heavy load when the product of the current bus voltage and the freewheeling time of the electric motor 40 exceeds a preset product threshold. It is to be understood that the determination of whether the preceding load parameter exceeds the corresponding threshold may be performed by the detection device 70, and the detection device 70 may transmit the determination result to the controller 60 so that the controller 60 knows whether the current load of the electric motor 40 belongs to the heavy load working condition or the no load/light load working condition. In addition, the method for detecting the current load of the electric motor 40 is not limited to the solution in which the preceding load parameter is compared with the corresponding threshold. The object here is to clarify whether the current load of the electric motor 40 belongs to the case where a subsequent solution needs to be adopted, that is, whether the current load of the electric motor 40 belongs to the heavy load working condition. Other load detection methods may be adaptively introduced.

In the case where the load parameter of the electric motor 40 exceeds the corresponding threshold, that is, when the electric motor 40 is in the heavy load working condition, the controller 60 may use a first modulation index to determine the corresponding first voltage vector, overmodulate the first voltage vector to obtain a first modulated voltage vector, and then output a first PWM signal corresponding to the first modulated voltage vector to the driver circuit 80 so that according to the first PWM signal, the driver circuit 80 drives the electric motor 40 to operate, where the first modulation index is greater than or equal to 0.9069 and less than or equal to 1.

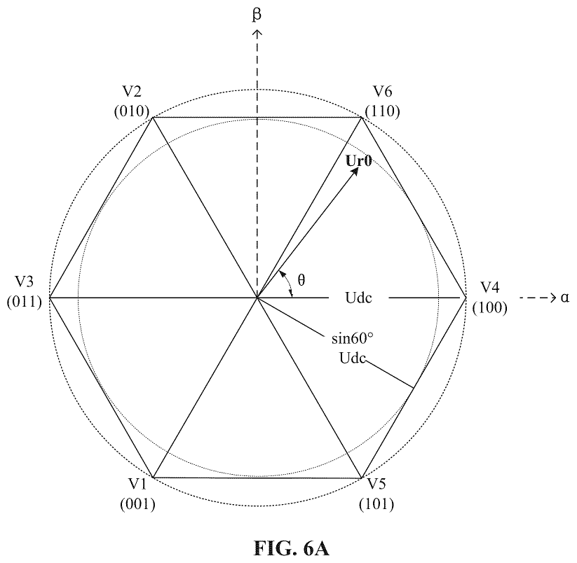

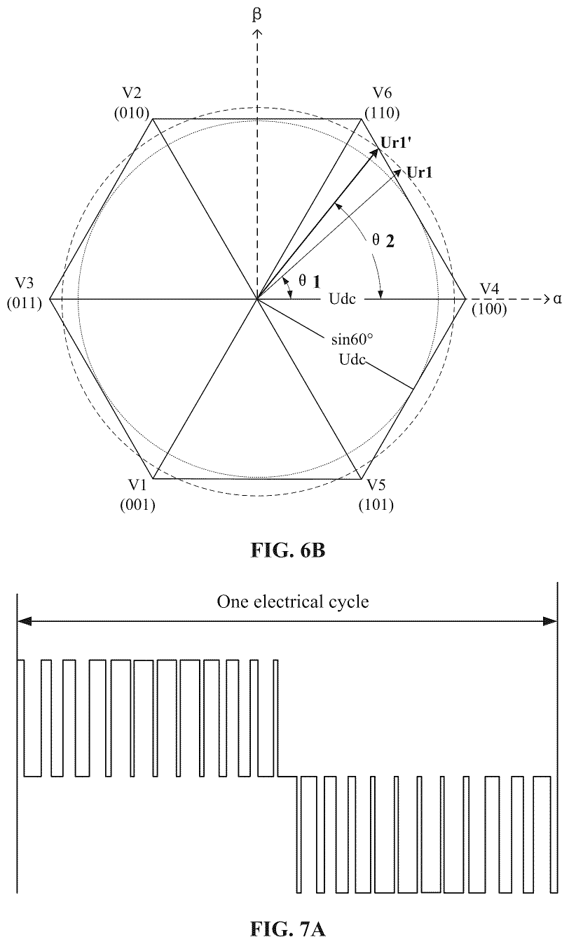

First, the following case is described: the controller 60 determines the voltage vector based on the modulation index and outputs the corresponding PWM signal so that according to the PWM signal, the driver circuit 80 drives the electric motor 40 to operate. Referring to FIG. 6A, a regular hexagon in a two-phase stationary coordinate system (α-β coordinate system) of the electric motor is shown. The regular hexagon is the limit voltage vector trajectory that can be achieved by the controller 60. The side length value is related to the amplitude of the direct current bus voltage Udc and is specifically, 2/3Udc. The center point of the hexagon and the six vertices can form six non-zero vectors, and the size of each non-zero vector is also 2/3Udc. Based on the above, three-bit binary numbers are used to represent the conduction states of the six switching transistors in the preceding three-phase bridge circuit. “1” and “0” represent that the upper bridge switch and the lower bridge switch in a group of half bridges are turned on, respectively, and “100” represents that the switching transistors Q1, Q6, and Q2 are turned on. In addition to (000) and (111), six conduction states of the switching transistors exist. The preceding six non-zero vectors correspond to the six conduction states, respectively, and (000) and (111) correspond to zero vectors V0 and V7, that is, the center point of the hexagon. The voltage vector Ur0 in FIG. 6A is used as an example. The voltage vector Ur0 may be a resultant of two non-zero vectors V4 and V6 and two zero vectors V0 and V7. Based on the relationship between the resultant voltage vector Ur0, the non-zero vectors, and the zero vectors, the controller 60 may output a corresponding PWM signal to the driver circuit 80 so that based on the PWM signal, the driver circuit 80 adjusts the sequence in which the preceding six switching transistors are on and the time for which each switching transistor is on, thereby adjusting the energized state of each phase winding in the electric motor 40. In this manner, the stator generates a magnetic field suitable for the current rotor speed and position. The seven-segment PWM is used as an example. The PWM signal corresponding to the voltage vector Ur0 achieves the following conduction states of the switching transistors V0 (000)→V4 (100)→V6 (110)→V7 (111)→V7 (111)→V6 (110)→V4 (100)→V0 (000) in sequence. The action duration of each vector in the preceding stages may be adaptively adjusted according to the included angle θ between the voltage vector Ur and the α-axis.

In the present application, the controller 60 may determine the voltage vector based on the modulation index to implement the preceding solution. The modulation index (also referred to as the modulation coefficient and denoted as m) is related to the preceding voltage vector Ur and the amplitude of the direct current bus voltage Udc. In the present application, the modulation index is defined as formula (1).

$$m = \frac{Ur}{\frac{2}{π} Udc} \qquad ( 1 )$$

In conjunction with FIG. 6A, an inscribed circle and a circumscribed circle are made for the preceding regular hexagon, the radius of the inscribed circle is Udc/\sqrt{3}, and the radius of the circumscribed circle is Udc. It can be seen that in the case where the amplitude of the voltage vector does not exceed the radius of the inscribed circle, the voltage vector is always located in the preceding regular hexagon, the voltage vector may be a resultant of the preceding non-zero vectors and zero vectors, the region inside the inscribed circle is recorded as the linear modulation region, and the inscribed circle is referred to as the voltage limit circle; and in the case where the amplitude of the voltage vector exceeds the radius of the inscribed circle, the voltage vector may be located outside the preceding regular hexagon, the voltage vector may not be a resultant of the preceding non-zero vectors and zero vectors, and the region between the preceding inscribed circle and the preceding circumscribed circle is recorded as the overmodulation region. The radius of the voltage limit circle serving as the boundary between the linear modulation region and the overmodulation region is Udc/\sqrt{3}. The modulation index m on the boundary is equal to

$$\frac{1 / \sqrt{3}}{2 / π} ,$$

that is, 0.9069. In other words, when the modulation index m ranges from 0 to 0.9069, the voltage vector Ur is located in the linear modulation region; and when the modulation index m ranges from 0.9069 to 1, the voltage vector Ur is located in the overmodulation region.

In the case where the load parameter provided by the detection device 70 exceeds the corresponding threshold, that is, when the electric motor 40 is in the heavy load working condition, the controller 60 uses the first modulation index m1 ranging from 0.9069 to 1 to determine the corresponding first voltage vector Ur1. In some examples, the first modulation index m1 may be a preset fixed value, for example, may be preset according to actual scenario requirements during the power tool performance test. In other examples, the first modulation index m1 may be a change value dynamically adjusted within a range from 0.9069 to 1, for example, may be positively correlated to the current load of the electric motor 40.

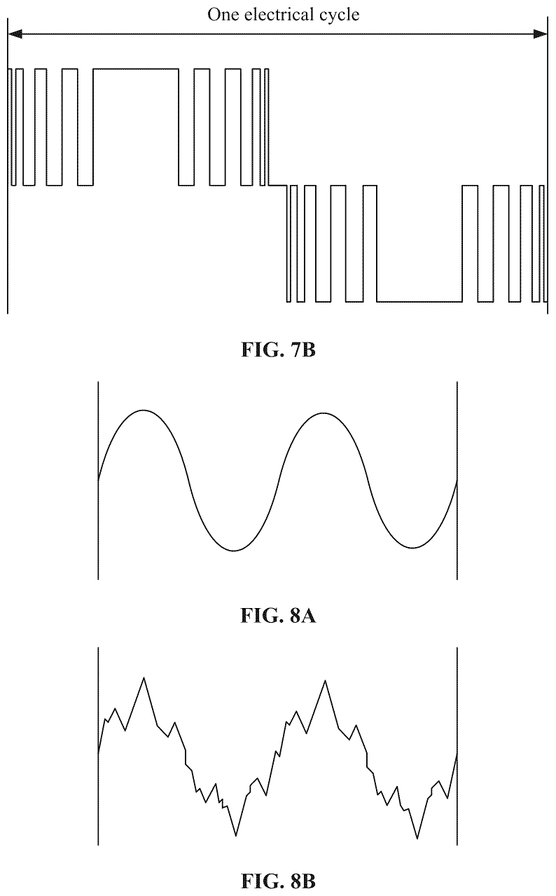

The first voltage vector Ur1 obtained according to the first modulation index m1 greater than or equal to 0.9069 and less than or equal to 1 exceeds the preceding voltage limit circle, and the controller 60 overmodulates the first voltage vector Ur1 to obtain the first modulated voltage vector Ur1′. The first modulated voltage vector Ur1′ obtained through overmodulation falls within the preceding regular hexagon range. The controller 60 may output the corresponding first PWM signal based on the first modulated voltage vector Ur1′ so that based on the first PWM signal, the driver circuit 80 drives the electric motor 40 to operate. Referring to FIG. 7B, FIG. 7B shows the phase voltage waveform of the electric motor 40 when the controller 60 uses the first modulation index m1 ranging from 0.9069 to 1 to control the electric motor 40 to operate; and FIG. 7A shows the phase voltage waveform of the electric motor 40 when the controller 60 uses the modulation index m ranging from 0 to 0.9069 to control the electric motor 40 to operate.

It is to be noted here that in the heavy load working condition, the rotational speed of the electric motor 40 of the power tool 100 is reduced, the current increases, and the temperature increases, causing that the performance, operating feel, and working duration of the power tool 100 cannot be maintained in a good state as in the light load working condition. Therefore, in the present application, in the heavy load working condition, the controller 60 in the power tool 100 uses the modulation index ranging from 0.9069 to 1 to overmodulate the voltage vector. As the size of the voltage vector increases, the utilization rate of the direct current bus voltage increases, and the maximum rotational speed that the electric motor 40 can reach increases accordingly. Moreover, in the case where the power of the power supply device 50 is constant, the amplitude of the phase current of the electric motor 40 is relatively reduced, and the temperature rise of components such as field-effect transistors in the driver circuit 80 is reduced, thereby improving the load capacity of the electric motor 40 and improving performances such as the temperature rise and service life.

The controller 60 overmodulates the first voltage vector Ur1 to obtain the first modulated voltage vector Ur1′ in multiple optional methods. In some examples, the controller 60 may overmodulate the portion of the first voltage vector Ur1 that exceeds the preceding linear modulation region. In an example, referring to FIG. 6B, if the first voltage vector Ur1 obtained based on the first modulation index m1 exceeds the range of the inscribed circle and the range of the regular hexagon, the first voltage vector Ur1 may be rotated until the first voltage vector Ur1 falls exactly into the hexagon according to the principle of compensating the angle without changing the amplitude, thereby determining the corresponding first modulated voltage vector Ur1′ according to the first voltage vector Ur1. In the two-phase stationary coordinate system, the included angle between the first voltage vector Ur1 and the α-axis is θ1, the included angle between the first modulated voltage vector Ur1′ and the α-axis is θ2, and (θ2-θ1) is the compensation angle from the first voltage vector Ur1 to the first modulated voltage vector Ur1′.

It is to be noted here that the preceding definition of the modulation index m is not unique. In some examples, the modulation index m is defined as the amplitude ratio of the voltage vector Ur to 2/3Udc as shown in formula (2); and in other examples, the modulation index m is defined as the amplitude ratio of the voltage vector Ur to Udc/\sqrt{3} as shown in formula (3). Based on the above, Ur equal to Udc/\sqrt{3} is used as the boundary point between the linear modulation region and the overmodulation region and is recorded as the overmodulation point. In the definition formula (2), m equal to

$$\frac{\sqrt{3}}{2}$$

is used as the overmodulation point, linear modulation is performed when m is in [0, 0.866], overmodulation is performed when m is in [0.866, 1], and m equal to 1 is used as the maximum modulation point. At the maximum modulation point, the controller 60 actually controls the operation of the electric motor 40 in the six-step commutation method. In the definition formula (3), m equal to 1 is used as the overmodulation point, linear modulation is performed when m is in [0, 1], overmodulation is performed when m is in [1, 1.15], and m equal to 1.15 is used as the maximum modulation point as shown in Table 1 below. Therefore, in the case where the modulation index or modulation coefficient m has a different definition, the range of the first modulation index m used by the controller 60 in the power tool 100 for the heavy load working condition may be 0.866 to 1 or 1 to 1.15, and similar cases should be included in the protection scope of the preceding solution.

$$m = \frac{Ur}{\frac{2}{3} Udc} \qquad ( 2 )$$

$$m = \frac{Ur}{\frac{1}{\sqrt{3}} Udc} \qquad ( 3 )$$

TABLE 1

| | | Overmodulation | Maximum |
|---|---|---|---|
| | Starting point | point | modulation point |
| Definition (1) | 0 | 0.9069 | 1 |
| Definition (2) | 0 | 0.866 | 1 |
| Definition (3) | 0 | 1 | 1.15 |

In some examples, in the case where the load parameter transmitted by the detection device 70 does not exceed the corresponding threshold, that is, in the no load/light load working condition, the controller 60 of the power tool 100 may use a second modulation index m2 ranging from 0 to the preceding first modulation index m1 to determine the corresponding second voltage vector Ur2 for subsequent generation and output of a second PWM signal. Considering that the larger the modulation index m used by the controller 60, the larger the size of the voltage vector, and the higher the utilization rate of the direct current bus voltage, however, at the same time, the increase in the modulation index m leads to an increase in the harmonics and interference of the phase current of the electric motor 40 and may cause sudden changes. Referring to FIG. 8A, FIG. 8A shows the phase current waveform of the electric motor 40 in an ideal state. When the modulation index m is relatively small, the phase current of the electric motor 40 basically presents the waveform shown in FIG. 8A; and when the modulation index m increases and approaches 1, for example, when m is equal to 0.98, referring to FIG. 8B, the phase current waveform of the electric motor 40 produces a large number of glitches or oscillations. In the no load/light load working condition, the amplitude of the phase current of the electric motor 40 is relatively small. If a larger modulation index m is used, the harmonic component causes more significant interference to the phase current of the electric motor 40. The preceding problem is particularly serious in the case where the electric motor 40 is a sensorless brushless motor that relies on the current/voltage to achieve operation control. Therefore, in the present application, in the no load/light load working condition, the controller 60 in the power tool 100 uses the second modulation index m2 ranging from 0 to the first modulation index m1 to determine the second voltage vector, which is different from the heavy load working condition. In this manner, the harmonic component is reduced, the phase current stability is ensured, and the power tool 100 can maintain a good working state in the no load/light load working condition, thereby avoiding problems such as rotational speed fluctuations.

In some examples, the second modulation index m2 ranges from 0 to 0.9069, and the controller 60 may output the second PWM signal corresponding to the second voltage vector Ur2 to the driver circuit 80. In other examples, the second modulation index m2 ranges from 0.9069 to the first modulation index m1, and the controller 60 overmodulates the second voltage vector Ur2 obtained by the second modulation index m2 to obtain a second modulated voltage vector Ur2′, and outputs the second PWM signal corresponding to the second modulated voltage vector Ur2′ to the driver circuit 80. For the description in which the second modulated voltage vector Ur2′ is obtained by overmodulating the second voltage vector Ur2, reference may be made to the preceding relevant description in which the first modulated voltage vector Ur1′ is obtained by overmodulating the first voltage vector Ur1.

In some examples, to ensure the smooth operation and stable performance of the electric motor 40, when the load parameter of the electric motor 40 changes from the no load/light load working condition in which the corresponding threshold is not exceeded to the heavy load working condition in which the corresponding threshold is exceeded, the controller 60 of the power tool 100 may control the modulation index for generating the PWM signal to smoothly transition from the second modulation index m2 to the first modulation index m1. In this process, the determination of the voltage vector and the output of the pulse modulation signal are achieved based on the modulation index in the smooth transition. The phase voltage of the electric motor 40 gradually changes from the waveform shown in FIG. 7A to the waveform shown in FIG. 7B within a certain duration. Correspondingly, when the heavy load working condition changes to the no load/light load working condition, the controller 60 may control the modulation index to smoothly transition from the first modulation index m1 to the second modulation index m2. In some examples, when the power tool 100 changes from the no load/light load working condition to the heavy load working condition, the controller 60 controls the modulation index m to rise linearly from the second modulation index m2 to the first modulation index m1 within a first preset duration T1. In other examples, when the power tool 100 changes from the heavy load working condition to the no load/light load working condition, the controller 60 controls the modulation index m to drop linearly from the first modulation index m1 to the second modulation index m2 within a second preset duration T2. The first preset duration T1 may be equal to or different from the second preset duration T2. In an example, the first preset duration T1 and the second preset duration T2 are each 80 ms. In addition, the transition between the first modulation index m1 and the second modulation index m2 may be nonlinear, and the transition duration between the first modulation index m1 and the second modulation index m2 may be a non-fixed value.

In other examples, to make the operation control of the electric motor 40 respond quickly to the change in the load of the power tool 100, when the load parameter of the electric motor 40 changes from the no load/light load working condition in which the corresponding threshold is not exceeded to the heavy load working condition in which the corresponding threshold is exceeded, the controller 60 of the power tool 100 may control the modulation index for generating the PWM signal to directly switch from the second modulation index m2 to the first modulation index m1. The phase voltage of the electric motor 40 instantly changes from the waveform shown in FIG. 7A to the waveform shown in FIG. 7B. Correspondingly, when the heavy load working condition changes to the no load/light load working condition, the controller 60 may control the modulation index to directly switch from the first modulation index m1 to the second modulation index m2.

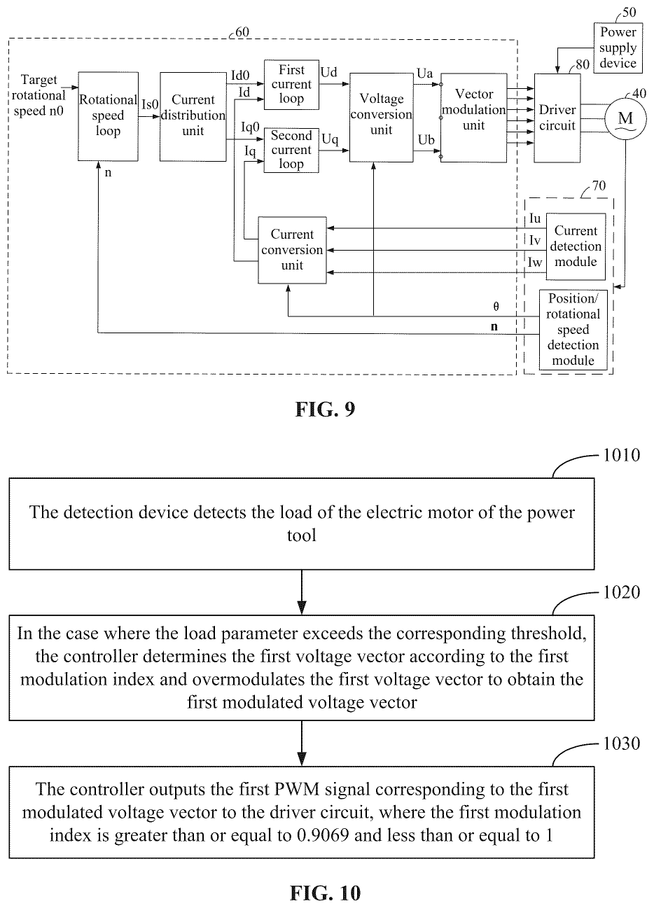

In some examples, referring to FIG. 9, the controller 60 may include a rotational speed loop, a current distribution unit, a first current loop, a second current loop, a current conversion unit, a voltage conversion unit, and a vector modulation unit. The detection device 70 may include a current detection module and a position/rotational speed detection module. The rotational speed loop is provided with the target rotational speed n0 and is connected to the rotational speed detection module to acquire the actual rotational speed n of the electric motor 40 detected by the rotational speed detection module. The rotational speed loop determines the current target current Is0 of the electric motor 40 based on the target rotational speed n0 and the actual rotational speed n.

The current distribution unit is connected to the preceding rotational speed loop and performs distribution to form the direct-axis target current Id0 and the quadrature-axis target current Iq0 based on the target current Is0. The preceding target current Is0, the direct-axis target current Id0, and the quadrature-axis target current Iq0 are each a vector with a magnitude and a direction. The direct-axis target current Id0 and the quadrature-axis target current Iq0 are perpendicular to each other, and the target current Is0 is a resultant of the direct-axis target current Id0 and the quadrature-axis target current Iq0.

The current conversion unit is connected to the current detection module and can acquire the phase currents Iu, Iv, and Iw of the three-phase windings and convert the phase currents from the three-phase stationary coordinate system to the two-phase rotation coordinate system to obtain the direct-axis actual current Id and the quadrature-axis actual current Iq. The first current loop is connected to the current distribution unit and the current conversion unit and can acquire and determine the first adjustment voltage Ud based on the direct-axis target current Id0 and the direct-axis actual current Id. The second current loop is connected to the current distribution unit and the current conversion unit and can acquire and determine the second adjustment voltage Uq based on the quadrature-axis target current Iq0 and the quadrature-axis actual current Iq.

The voltage conversion unit is connected to the first current loop and the second current loop and can acquire the first regulation voltage Ud and the second regulation voltage Uq and convert the first regulation voltage Ud and the second regulation voltage Uq from the two-phase rotation coordinate system to the two-phase stationary coordinate system to obtain the first voltage control quantity Ua and the second voltage control quantity Ub. The vector modulation unit is connected to the voltage conversion unit and can acquire the first voltage control quantity Ua and the second voltage control quantity Ub. Based on the current modulation index, the vector modulation unit linearly modulates or overmodulates the first voltage control quantity Ua and the second voltage control quantity Ub, generates corresponding PWM signals, and outputs the PWM signals to the driver circuit 80.

In some examples, by adopting the preceding control solution, the waveform of the three-phase current of the electric motor 40 in the power tool 100 can be kept basically sinusoidal, and the three phases of voltages can be kept basically 120° out of phase with each other.

To sum up, in the present application, the controller 60 of the power tool 100 adapts to the current loads of the electric motor 40, uses different modulation indices to determine the voltage vectors, and outputs the corresponding pulse modulation signals, and based on different PWM signals, the driver circuit 80 adjusts the stator windings in the electric motor 40 to the energized states suitable for the loads. Therefore, in some examples, the controller 60 of the power tool 100 uses different modulation indices in the case where the load parameters of the electric motor 40 are different. In some examples, to achieve a rapid increase in the rotational speed of the electric motor 40 in the no load/light load working condition, when the load parameter of the electric motor 40 does not exceed the corresponding threshold, the controller 60 of the power tool 100 may use the second modulation index to determine the second voltage vector, overmodulate the second voltage vector to obtain the second modulated voltage vector, and then output the second PWM signal corresponding to the second modulated voltage vector to the driver circuit 80 so that according to the second PWM signal, the driver circuit 80 drives the electric motor 40 to operate, where the second modulation index is greater than or equal to 0.9069 and less than or equal to 1. To ensure that the electric motor 40 operates smoothly in the heavy load working condition, when the load parameter exceeds the corresponding threshold, the controller 60 may use the first modulation index to determine the first voltage vector and perform the subsequent generation and output of the first PWM signal according to the first voltage vector, where the first modulation index is greater than or equal to 0 and less than the preceding second modulation index.

The benefit of the present application lies in the following: the controller of the power tool adjusts the control method for the power tool according to the current actual load; and in the heavy load working condition where the load exceeds the threshold, the controller of the power tool uses a suitable modulation index to overmodulate the voltage vector and outputs the corresponding PWM signal to the driver circuit so that in the heavy load working condition, the voltage utilization rate can be improved, and the current amplitude and the temperature rise of the driver circuit can be reduced, thereby improving the related performances such as the load capacity, the heavy load working duration, and the service life of the power tool.

Correspondingly, FIG. 10 is a control flowchart of a power tool, and the flow may include the steps below.

In 1010, the detection device 70 of the power tool 100 detects the load parameter of the electric motor 40 of the power tool 100.

In 1020, in the case where the load parameter exceeds the corresponding threshold, the controller 60 of the power tool 100 determines the first voltage vector according to the first modulation index and overmodulates the first voltage vector to obtain the first modulated voltage vector.

In 1030, the controller 60 outputs the first PWM signal corresponding to the first modulated voltage vector to the driver circuit 80 of the power tool 100, where the first modulation index is greater than or equal to 0.9069 and less than or equal to 1.

The basic principles, main features, and advantages of the present application are shown and described above. It is to be understood by those skilled in the art that the preceding examples do not limit the present application in any form, and all technical solutions obtained through equivalent substitutions or equivalent transformations fall within the scope of the present application.

What is claimed is:

1. A power tool, comprising:
a functional piece;
an electric motor for driving the functional piece to operate;
a power supply device for supplying power to at least the electric motor;
a detection device connected to the electric motor and configured to detect a duration of each phase of the electric motor, wherein the duration of each phase of the electric motor is a duration in which a rotor of the electric motor is located in each electrical angle sector; and
a controller connected to the detection device and the electric motor configured to: obtain a duration of a rising phase and a duration of a falling phase of the electric motor according to the duration of each phase of the electric motor; determine when the electric motor has an uneven commutation phenomenon based on the duration of the rising phase and the duration of the falling phase; and dynamically adjust a rising commutation point and/or a falling commutation point of the electric motor based on a magnitude relationship between the duration of the rising phase and the duration of the falling phase when the electric motor has the uneven commutation phenomenon;
wherein a floating phase voltage increases from low to high within the duration of the rising phase, and the floating phase voltage decreases from high to low within the duration of the falling phase.

2. The power tool of claim 1, wherein the controller is configured to determine that the electric motor has the uneven commutation phenomenon when a difference between the duration of the rising phase and the duration of the falling phase exceeds a preset difference threshold or when a ratio of the duration of the rising phase to the duration of the falling phase exceeds a preset ratio threshold.

3. The power tool of claim 1, wherein the electric motor is a three-phase electric motor, the electric motor has six electrical angle sectors and corresponding six-phase durations, and the six-phase durations are durations of rising phases and falling phases that alternate with the rising phases.

4. The power tool of claim 1, wherein the duration of the rising phase and the duration of the falling phase are durations of two adjacent phases; or the duration of the rising phase is a sum of durations of three rising phases generated by one rotation of the rotor of the electric motor and the duration of the falling phase is a sum of durations of three falling phases generated by one rotation of the rotor of the electric motor.

5. The power tool of claim 1, wherein the controller is configured to adjust a first proportional point corresponding to the rising commutation point to change trigger timing of the rising commutation point and, control the electric motor to switch from a current rising phase to a next phase when the floating phase voltage of the electric motor rises from a lowest point to the first proportional point; and/or adjust a second proportional point corresponding to the falling commutation point to change trigger timing of the falling commutation point and, control the electric motor to switch from a current falling phase to a next phase when the floating phase voltage of the electric motor drops from a highest point to the second proportional point.

6. The power tool of claim 5, wherein the controller is configured to, when the electric motor has the uneven commutation phenomenon and when the duration of the rising phase is greater than the duration of the falling phase, reduce the first proportional point and/or reduce the second proportional point.

7. The power tool of claim 5, wherein the controller is configured to, when the electric motor has the uneven commutation phenomenon and when the duration of the rising phase is less than the duration of the falling phase, increase the first proportional point and/or increase the second proportional point.

8. The power tool of claim 5, wherein the controller is configured to adjust the first proportional point within a preset first proportional range and/or adjust the second proportional point within a preset second proportional range until the uneven commutation phenomenon of the electric motor is eliminated.

9. The power tool of claim 8, wherein the first proportional range is from 0.5 to 0.8, and the second proportional range is from 0.2 to 0.5.

10. The power tool of claim 1, wherein the controller is configured to adjust a first timer count corresponding to the rising commutation point to change trigger timing of the rising commutation point and, control the electric motor to switch to a next phase when a timer increment reaches the first timer count after the electric motor enters the rising phase; and/or adjust a second timer count corresponding to the falling commutation point to change trigger timing of the falling commutation point and, control the electric motor to switch to a next phase when the timer increment reaches the second timer count after the electric motor enters the falling phase.

11. A power tool, comprising:
a functional piece;
an electric motor for driving the functional piece to operate;
a power supply device for supplying power to at least the electric motor; and
a controller connected to the electric motor and configured to control a duration of each phase during the operation of the electric motor so that the duration of each phase of the electric motor remains basically the same, and the duration of each phase of the electric motor is a duration in which a rotor of the electric motor is located in each electrical angle sector.

12. A control method for a power tool, wherein the method comprises:
detecting a duration of each phase of an electric motor of the power tool, wherein the duration of each phase of the electric motor is a duration in which a rotor of the electric motor is located in each electrical angle sector;
obtaining a duration of a rising phase and a duration of a falling phase of the electric motor according to the duration of each phase of the electric motor and determining when electric motor has an uneven commutation phenomenon based on the duration of the rising phase and the duration of the falling phase; and
when the electric motor has the uneven commutation phenomenon, dynamically adjusting a rising commutation point and/or a falling commutation point of the electric motor based on a magnitude relationship between the duration of the rising phase and the duration of the falling phase;
wherein a floating phase voltage increases from low to high within the duration of the rising phase, and the floating phase voltage decreases from high to low within the duration of the falling phase.

13. The control method for a power tool of claim 12, wherein the electric motor is determined to have the uneven commutation phenomenon when a difference between the duration of the rising phase and the duration of the falling phase exceeds a preset difference threshold or when a ratio of the duration of the rising phase to the duration of the falling phase exceeds a preset ratio threshold.

14. The control method for a power tool of claim 12, wherein the electric motor is a three-phase electric motor, the electric motor has six electrical angle sectors and corresponding six-phase durations, and the six-phase durations are durations of rising phases and falling phases that alternate with the rising phases.

15. The control method for a power tool of claim 12, wherein the duration of the rising phase and the duration of the falling phase are durations of two adjacent phases; or the duration of the rising phase is a sum of durations of three rising phases generated by one rotation of the rotor of the electric motor and the duration of the falling phase is a sum of durations of three falling phases generated by one rotation of the rotor of the electric motor.

16. The control method for a power tool of claim 12, wherein dynamically adjusting the rising commutation point and/or the falling commutation point of the electric motor comprises: adjusting a first proportional point corresponding to the rising commutation point to change trigger timing of the rising commutation point and, controlling the electric motor to switch from a current rising phase to a next phase when the floating phase voltage of the electric motor rises from a lowest point to the first proportional point; and/or adjusting a second proportional point corresponding to the falling commutation point to change trigger timing of the falling commutation point and, controlling the electric motor to switch from a current falling phase to a next phase when the floating phase voltage of the electric motor drops from a highest point to the second proportional point.

17. The control method for a power tool of claim 16, wherein adjusting the first proportional point corresponding to the rising commutation point to change the trigger timing of the rising commutation point and/or adjusting the second proportional point corresponding to the falling commutation point to change the trigger timing of the falling commutation point comprises: when the electric motor has the uneven commutation phenomenon and when the duration of the rising phase is greater than the duration of the falling phase, reducing the first proportional point and/or reducing the second proportional point; and when the duration of the rising phase is less than the duration of the falling phase, increasing the first proportional point and/or increasing the second proportional point.

18. The control method for a power tool of claim 16, wherein dynamically adjusting the rising commutation point and/or the falling commutation point of the electric motor comprises: adjusting the first proportional point within a preset first proportional range and/or adjusting the second proportional point within a preset second proportional range until the uneven commutation phenomenon of the electric motor is eliminated.

19. The control method for a power tool of claim 18, wherein the first proportional range is from 0.5 to 0.8, and the second proportional range is from 0.2 to 0.5.
